(19) United States
(12) Patent Application Publication
(10) Pub. No.: US 2008/0014986 A1
(43) Pub. Date: Jan. 17, 2008

(54) Mobile Communication Terminal Capable Of Playing And Updating Multimedia Content And Method Of Playing The Same

(75) Inventor: Sung-Kyoon Yun, Gyeonggi-do (KR)

Correspondence Address: CANTOR COLBURN, LLP, 55 GRIFFIN ROAD SOUTH, BLOOMFIELD, CT, 06002, US

(73) Assignee: NEOMTEL CO., LTD., Seoul (KR)

(21) Appl. No.: 11/577,390

(22) PCT Filed: Nov. 17, 2005
(86) PCT No.: PCT/KR05/03900

§ 371 Date: Apr. 17, 2007

(30) Foreign Application Priority Data
Nov. 22, 2004 (KR) 1020040095884

(51) Int. Cl. H04M 1/00

(52) U.S. Cl. 455/556.1; 455/550.1

(57) ABSTRACT

A mobile communication terminal is provided, including a memory unit that stores a content file that includes a header, which has summary information concerning the content, object files, which are elements of the content to be played, a playback control command file, which operates the object files and describes the content, and a script file, which describes the size, motion, or characteristic of an object; a playback unit that loads the elements of the content to be played into a temporary storage area of the memory unit; and an update control unit that operates upon activation of the playback unit, and, when an event occurs, changes a script file among the elements of the content file to be played to a new script file downloaded through the wireless communication unit.

### TECHNICAL FIELD

The present invention relates to a mobile communication terminal that plays multimedia content and, more particularly, to a mobile communication terminal that plays multimedia content for the mobile communication terminal, which is produced in a standardized format, through a standard playback engine incorporated in the mobile communication terminal.

### BACKGROUND ART

The present applicant has provided standardized contents for standby screen of a mobile communication terminal and has filed a plurality of patent applications, i.e., Korean Patent Application Nos. 2000-42840 and 2000-79982. Recently, the present applicant has also filed Korean Patent Application No. 2003-14687 on Mar. 10, 2003 (Korean Patent Publication No. 2003-87525, disclosed on Nov. 14, 2003), which relates to a technology for providing interactive multimedia content on a standby screen.

The above-mentioned publication discloses a technology for providing interactive content by checking and performing commands issued by a user whenever each frame of the content for standby mode is played back. In order to respond to the user's commands, keys are first acquired from a key input queue. Next, it is determined whether or not there is an action, which corresponds to the acquired key and is previously defined as part of the content. If the action exists, the action is carried out. Examples of the action include control commands related to playing the content, such as jump, repetitive play, fast play or rewind, a vibration command, a sound output command, and the like.

However, in the above-mentioned prior art, there is a problem in that it is not possible to modify multimedia contents. Users desire to add their own produced images to the existing content, or to update the existing content.

### DISCLOSURE OF INVENTION

### Technical Solution

It is an object of the present invention to provide a mobile communication terminal that plays content that can be modified.

It is another object of the present invention to diversify functions of content played in a mobile communication terminal so that the content can have a variety of applications.

### Advantageous Effects

A mobile communication terminal according to the present invention can update through a network a script file that describes the size, motion, or characteristic of an object in content.

In addition, the present invention allows content providers to produce contents having various functions.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a mobile communication terminal according to an embodiment of the present invention; and

FIG. 2 is a flow chart of a method of playing multimedia content according to an embodiment of the present invention.

### BEST MODE FOR CARRYING OUT THE INVENTION

According to an aspect of the present invention, there is provided a mobile communication terminal that changes a script file, which describes the size, motion, and characteristic of an object file included in a content file to be played, to a new script file downloaded through a network.

Accordingly, it is possible to update the content in whole or in part.

According to another aspect of the present invention, there is provided a mobile communication terminal that changes a script file, which describes the size, motion, and characteristic of an object file included in a content file to be played, to a new script file downloaded through a network, when an event occurs.

Accordingly, it is possible to update the content in whole or in part, regardless of whether the content is being played or not.

Examples of the event for updating the script file include a typical event, such as a key operation event or a timer event, and an event in which a value of updated data satisfies a predetermined condition as the content is played.

### Mode for the Invention

Exemplary embodiments in accordance with the present invention will now be described in detail with reference to the accompanying drawings.

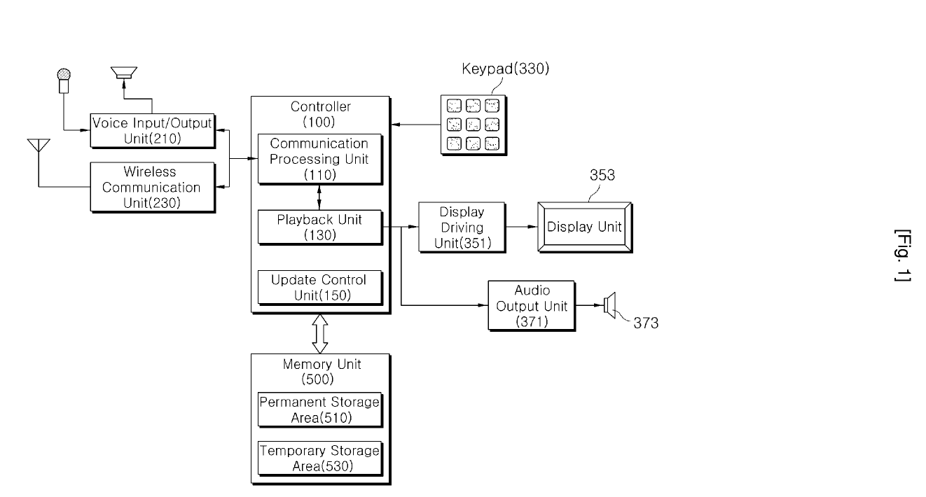

FIG. 1 is a block diagram of a mobile communication terminal according to an embodiment of the present invention. The mobile communication terminal includes a communication processing unit 110, a playback unit 130, an update control unit 150, a voice input/output unit 210, a wireless communication unit 230, a keypad 330, a display unit 353, an audio output unit 371, and a memory unit 500. The wireless communication unit 230 transmits/receives voice and data signals through a mobile communication network. The communication processing unit 110 processes the voice and data signals transmitted/received through the wireless communication unit 230. The voice input/output unit 210 converts the voice signal processed by the communication processing unit 110 into an audible sound, or converts a voice signal inputted from the outside and transmits it to the communication processing unit 110. The memory unit 500 stores content data. The playback unit 130 loads elements of content to be played into a temporary storage area 530 of the memory unit 500, and plays the content. The display unit 353 displays images played back in the playback unit 130. The audio output unit 371 outputs audio signals played back in the playback unit 130. The update control unit 150 operates upon activation of the playback unit 130, and changes a script file among the elements of the content file to be played to a script file downloaded through the wireless communication unit 230.

The wireless communication unit 230 includes an antenna and a radio frequency (RF) circuit to communicate with base stations. The voice input/output circuit 210 transfers received voice to a user, converts a user's voice which is input from a microphone, and converts digital voice data into an analog voice signal and vice versa.

The voice input/output circuit 210 includes an audio amplifier, a filter, or the like.

The keypad 330 allows a user to enter data. Examples of the keypad 330 include a key button of a mobile communication terminal and a touch panel of a personal digital assistant (PDA). The display unit 353 may be a liquid crystal display (LCD) device. Image data outputted from the playback unit 130 is processed in the display driving unit 351 and converted into an analog signal for driving the display unit 353. The term “display unit” may refer to a device including a display driving unit or the like.

The audio output unit 371 converts the audio signal played by and outputted from the playback unit 130 into an audio signal and outputs the audio signal through a speaker 373. The audio output unit 371 includes a digital/analog converter, an amplifier, or the like.

The memory unit 500 may be composed of a single memory module or a plurality of memory modules. The permanent storage area 510 may be a non-volatile memory, such as a read-only memory (ROM). The temporary storage area 530 may be a volatile memory, such as a random access memory (RAM). Both of them 510 and 530 may be provided as a single flash memory. The content stored in the memory unit 500 includes a header, which includes summary information concerning the content, object files, which are elements of the content to be played, a playback control command file, which operates the object files and describes the content, and a script file, which describes the size, motion, or characteristic of the object file. Each object file may be an image file, a sound file, a moving image file, or another content file.

The communication processing unit 110 decodes a signal received from the wireless communication unit 230 into digital voice/non-voice data, or vice versa. A baseband circuit of the wireless communication unit 230 and most circuits of the controller 100 are integrated into a commercially available IC chip. The IC chip includes hardware for communication processing, a digital signal processor, and a general-purpose microprocessor.

The playback unit 130 includes a playback engine for playing content, and a content file which is executed by the playback engine. The playback engine is incorporated in the mobile communication terminal, and reads the content stored in the permanent storage area 510 of the memory unit 500 into the temporary storage area 530 and plays the content. The playback unit 130 checks whether or not the elements of the content to be played are present in the permanent storage area 510 of the memory unit 500, loads the elements into the temporary storage area 530 of the memory unit 500, and plays the elements. When there are updated elements, the playback unit 130 loads the updated elements into the temporary storage area 530 and plays the updated elements.

The content stored in the permanent storage area 510 includes a header, which includes summary information concerning the content, object files, which are elements of the content to be played, and playback control commands. Examples of the object files include image files, sound files, or moving image files.

The playback engine of the playback unit 130 reads a content file from the permanent storage area 510 of the memory unit 500 into the temporary storage area 530, loads the object files from the information included in the header into a resource area, loads the playback control commands into an action area, loads a script file into a script area, sequentially reads and plays the object files loaded in the resource area according to the playback control command stored in the action area and the script command stored in the script area. When the content is updated, the playback engine of the playback unit 130 loads the updated file into the temporary storage area and plays the updated file. The term “action” in the present invention implies a set of playback control commands for implementing a single operation. Accordingly, when one of the object files constituting original content changes to another file, which has the same file name as but different data than the original object file, and is stored in the permanent storage area 510, the changed content is played back when it is run afterwards.

The playback control commands, for example, control a display order or delay time of a series of frames, and define content to be displayed for the respective frames. The respective frames may be displayed by overlapping plural layers of images each having transparent margin on a background image. In addition to the images, sounds can be also controlled in synchronization with playback of frames. Accordingly, it is possible to produce various multimedia contents by combining the playback control commands and the object files.

The script commands describe the size, motion, and characteristic of the objects that constitute a content file. A user changes or controls the objects that constitute the content file by the use of the script commands. The script commands can be conveniently written by the user in an authoring tool for authoring the multimedia content.

The authoring tool provides graphical user interface that loads object files for each frame and defines attributes and characteristics of the object files.

The update control unit 150 operates according to update scripts included in the content, and updates the content or at least one of object files that constitute the content. In addition, the update control unit 150 notifies the playback unit 130 that the content has been updated so that the playback unit 130 can play the updated content.

In one embodiment, the update scripts for defining the operation of the update control unit 150 are determined in relation to frames of the content. The playback control command that generates the frames checks before and/or after generating the frames whether or not there are scripts related to the frames. When an update script is included in the scripts, the content is updated. For example, in case of game content, the update script may be defined to change the costumes or appearance of a character in a specified frame.

In another embodiment, the update control unit 150 monitors whether or not an event occurs, and, when the event occurs, changes a script file of content to be played to a new script file downloaded through the wireless communication unit 230. That is, when an event occurs, the update control unit 150 accesses a content server corresponding to a designated network address through the wireless communication unit 230 to download a new script file, and changes an existing script file to the new script file.

The update control unit 150 operates according to another update script file loaded into the script area. The event for initiating the update process may be key operation or timer event. For example, when a key is pressed, a script file may be updated. Alternatively, the script file may be updated at regular intervals, such as everyday or every month.

The event for initiating the update process may be an event in which a value of updated data satisfies a predetermined condition while content is being played. For example, in case of game content, when a game ranking or a game point reaches a pre-determined level, the characteristics or appearance of a corresponding object can be changed by updating script files.

In one embodiment, the update control unit 150 may be a routine executed as an independent thread which runs when the playback unit 130 is activated. The update control unit 150 updates the object and notifies the playback unit 130 that the content has been updated. The playback unit 130 reads the updated script file from the permanent storage area 510 into the temporary storage area 530, and plays the updated content. Accordingly, it is possible to change and play the content while the content is played. The update control unit 150 manages the definition of an event and a script which defines an action corresponding to the defined event. The update control unit 150 monitors whether or not the defined event occurs, and, when the event occurs, executes an action corresponding to the event.

In another embodiment, the update control unit 150 may be a conceptual expression of playback control commands which are distributed in the playback unit 130. That is, a command to generate a frame and/or a command to output the generated frame among the playback control commands includes the definition of an event which causes a script for defining a specified action to be executed. For example, when a ‘SEND’ button of a mobile phone is pushed while the playback engine is playing a specified content, a command to generate a frame executes a predetermined script in response to this event. The script may be a process for updating part of objects of the content which is currently played through a network.

The update script may include information concerning an address of a network resource that provides content to be updated. The update control unit 150 can access the network resource through the wireless communication unit 230 under the control of the update script, and download the content or the object files of the content to update existing content.

The following is an example of the update script.

ext_importMovie(http://211.233.24.178/vis20Dm/files/photones1.vis, “newm”, “loading”, “nerror”);

ext_replaceMovieClip(“oldm”, “newm”)

ext_saveResource(“newm”)

The function ext_importMovie( ) is a function of receiving a file from a network and making it a movie clip symbol. The function ext_replaceMovieClip( ) is a function of replacing an existing movie clip with the movie clip symbol received from the network. The function ext_saveResource( ) is a function of storing the movie clip symbol in the permanent storage area 510, and allowing the updated movie clip information to be played. When the function ext_importMovie( ) is executed, a mobile communication terminal requests and receives a corresponding file from URL, which is defined in a parameter, using the HTTP protocol. If the replaced movie clip information is not stored in the permanent storage area 510, the content, which is previously stored in the permanent storage area 510 and is not updated, will be played back. At this time, another script file, which defines the size, characteristic, or motion of the object, may be updated.

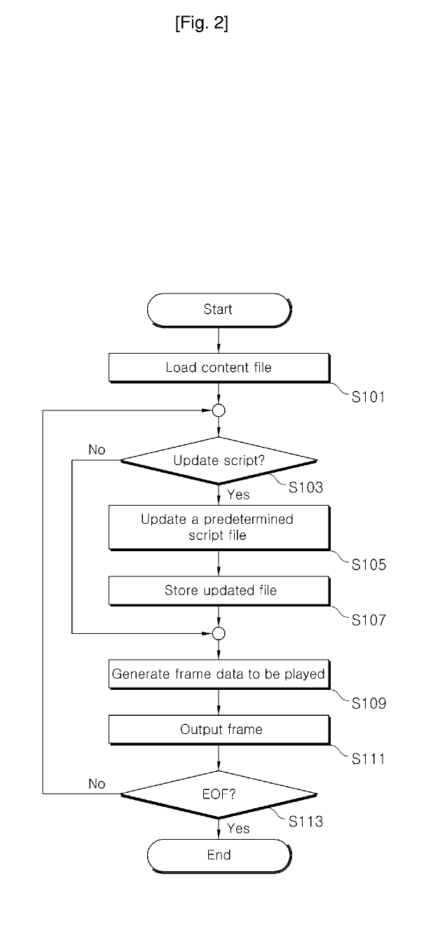

A method of playing multimedia content in a mobile communication terminal according to another embodiment of the present invention will now be described in detail with reference to FIG. 2. FIG. 2 is a flow chart of a method of playing content according to an embodiment of the present invention. The method includes the operations of sequentially reading object files included in a content file according to playback control commands included in the content file (operation S101), and performing an update operation when there is an update script to update at least one of the script files while the loaded content is being played (operation S103), updating at least one of script files stored in the script area among the content file under the control of the update script (operation S105), generating frame data to be played (operation S109), and outputting the generated frame data (operation S111).

In one embodiment, the content file may include a header which has summary information concerning the content, object files which are elements of the multimedia content to be updated, a playback control command file which operates the object files and describes the content, and a script file which describes the size, motion, or characteristic of the object. Each object file may be at least one of image files, sound files, and moving image files. The content files may be recorded on a storage unit such as a ROM or a hard disk of a host computer, or may be transferred through a network. The content file may be compressed into a single file to reduce the file size. The present invention is construed to include a recording medium that stores the content thus configured.

The content file is read from the permanent storage area 510 of the memory unit into a temporary storage area 530. When a file is compressed and stored, the operation of decompressing the compressed file may be added before reading the compressed file. The object files are loaded into the resource area by making reference to information included in the header, the playback control command file is loaded into the action area, and the script file is loaded into the script area (operation S101).

In one embodiment, after the operation S101, the update control unit 150 checks whether or not there is a script which is set in connection with the frame currently played. When there is a script, the script is performed. When the script is an update script, a process for updating the content is performed (operation S103).

In one embodiment, after the operation S101, the update control unit 150 checks a queue for storing events to check whether or not there is an action script defined in connection with a current event (operation S103). For example, the update control unit 150 checks a keypad queue to check whether or not there is an action defined for a single or a set of input keys. In one embodiment, in operation S103, when the playback control command starts to play each frame, the queue for storing events is checked to check whether or not there is an update script defined in connection with a current event.

When there is a corresponding action, at least one of script files stored in the script area changes to a new script file downloaded through a network under the control of an update script included in the action (operation S105). An element preferably has the same file name as but different data than an existing element since it is not necessary to change another playback control command or script file. In this case, the content stored in the temporary storage area 530 of the memory unit 500 is updated. The update operation of the update control unit 150 that is performed by checking the event queue and processing the corresponding action script is preferably performed before and/or after each frame is generated since the frames are frequently output at regular intervals. If there is no action script defined with respect to a combination of possible events in a current event queue, it proceeds to a frame generating operation without the above-mentioned action.

After the operation S105, operation S107 is further included in which the script file that is an element of the updated content file substitutes a corresponding script file which is previously stored in the permanent storage area 510 of the memory unit 500. Accordingly, when the playback engine is terminated and restarted, the updated content is loaded and played.

Next, the playback unit 130 sequentially reads the object files loaded into the resource area and generate frame data to be played according to the playback control commands stored in the action area and the updated script commands (operation S109).

In the operation S109, the object files loaded into the resource area are sequentially read to generate frame data to be played according to the playback control commands loaded into the action area and the script commands loaded into the script area. The playback control command arranges the object files on each layer and specifies the attributes of the object files to configure a frame. When there is a script file related to the frame, the script file is first executed to change the object file to another file, or to change or redefine the attribute of the object file.

When the frame is played, a plurality of object files, such as a plurality of image files that configures a plurality of layers of each frame, and sound files that are played in synchronization with the frame, may be involved. The generated frame is output through the display unit 353 and the audio output unit 371 (operation S111).

Next, the playback unit 130 checks the playback control commands to determine whether or not the playback operation of the content file is completely terminated. If the playback operation is not terminated, it returns to the operation S103 to generate next frame data. If terminated, the process is terminated (operation S113).

The above-mentioned update operation of the script file will now be described with reference to a puppy as an example of the content. The puppy is assumed to consist of objects of head, body, legs 1, 2, 3 and 4, tail, and sound. The objects are as follows:

TABLE 1

| Head | Body | Tail | Sound |
|---|---|---|---|
| head1 | body1 (walking) | tail1 (drooped) | sound1 (barking) |
| (expressionless) | | | |
| head2 (barking) | body2 (sitting) | tail2 (wagging) | sound2 (snarling) |
| head3 (snarling) | | | |

In this case, a text file of script data that defines the motion of the puppy objects in the content is compressed and transferred to a mobile communication terminal. The mobile communication terminal receives and analyzes the file and extracts and plays the content.

For example, suppose that the puppy object is included in the frame and is composed of sub-objects of head, body, and tail.

The following script is included in the puppy object.

function dog_action( )

{
_root.dog.head = head1; (head object)
_root.dog.body = body2; (body object)
_root.dog.tail = tail1; (tail object)
_root.dog.sx = 0; (X-axis reference coordinate)
_root.dog.sy = 1; (Y-axis reference coordinate)
}

{
_root.dog.head = head2;
_root.dog.body = body1;
_root.dog.tail = tail1;
_root.dog.sound = sound1;
_root.dog.sx = 20;
_root.dog.sy = 21;
}

This script represents the puppy which stands barking with its tail drooped at coordinates (20, 21).

Accordingly, it is possible to change the motion, position, or characteristic of the object that constitutes the content.

As apparent from the above description, the mobile communication terminal according to the present invention can update through a network a script file that describes the size, motion, or characteristic of an object in content.

In addition, the present invention allows content providers to produce contents having various functions.

While the present invention has been described with reference to exemplary embodiments thereof, it will be understood by those skilled in the art that various changes in form and details may be made therein without departing from the scope of the present invention as defined by the following claims.

1. A mobile communication terminal that plays multimedia content, comprising:
a wireless communication unit that transmits/receives voice and data signals through a mobile communication network;
a communication processing unit that processes the voice and data signals transmitted/received through the wireless communication unit;
a voice input/output unit that converts the voice signal processed by the communication processing unit into an audible sound, or transmits a voice signal inputted from the outside to the communication processing unit;
a memory unit that stores a content file that includes a header, which has summary information concerning the content, object files, which are elements of the content to be played, a playback control command file, which operates the object files and describes the content, and a script file, which describes the size, motion, or characteristic of an object;
a playback unit that loads the elements of the content to be played into a temporary storage area of the memory unit and plays the content;
a display unit that displays images played by the playback unit;
an audio output unit that outputs an audio signal played by the playback unit; and
an update control unit that operates upon activation of the playback unit, and changes a script file among the elements of the content file to be played to a new script file downloaded through the wireless communication unit.

2. The mobile communication terminal of claim 1, wherein the update control unit monitors whether or not an event occurs, and updates the script file when the event occurs.

3. The mobile communication terminal of claim 1, wherein the operation of the update control unit is controlled by another update script file loaded into the script area.

4. The mobile communication terminal of claim 2, wherein the event of the update control unit is at least one of a key operation event and a timer event.

5. The mobile communication terminal of claim 2, wherein the event of the update control unit is an event in which a value of updated data satisfies a predetermined condition as the content is played.

6. A mobile communication terminal comprising:
a playback unit that reads from a permanent storage area into a temporary storage area a content file that includes a header, which has summary information concerning the content, object files, which are elements of the content to be played, a playback control command file, which operates the object files and describes the content, and a script file, which describes the size, motion, or characteristic of an object, loads the object files into a resource area from information included in the header, loads the playback control command file into an action area, loads the script file into a script area, sequentially reads and plays the object files loaded into the resource area according to the playback control command loaded into the action area and the script loaded into the script area, and, when the content is updated, loads at least an updated file into the temporary storage area and plays the updated content; and
an update control unit that downloads at least one script file among elements of the content through a network and notifies the playback unit that the content has been updated.

7. The mobile communication terminal of claim 6, wherein the update control unit monitors whether or not an event occurs, and updates a script file that is set to be updated corresponding to the event when the event occurs.

8. The mobile communication terminal of claim 7, wherein the event of the update control unit is at least one of a key operation event and a timer event.

9. The mobile communication terminal of claim 7, wherein the event of the update control unit is an event in which a value of updated data satisfies a predetermined condition as the content is played.

10. A method of playing multimedia content in a mobile communication terminal, comprising the operations of:
a) checking whether or not a script update event occurs at the time when a new frame starts to be played;
b) downloading and substituting a corresponding script file through a network when the event occurs;
c) sequentially reading an object file and generating frame data to be played according to a playback control command and an updated script command, and controlling at least one of the size, motion, and characteristic of the object file according to the script command; and
e) outputting the generated frame data.

11. The method of claim 10, wherein the event of is at least one of a key operation event and a timer event.

12. The method of claim 10, wherein the event of is an event in which a value of updated data satisfies a predetermined condition as the content is played.

13. A method of playing multimedia content in a mobile communication terminal, comprising the operations of:
a) reading from a permanent storage area of a memory unit into a temporary storage area a content file that includes a header, which has summary information concerning the content, object files, which are elements of the content to be played, a playback control command file, which operates the object files and describes the content, and a script file, which describes the size, motion, or characteristic of an object, loading the object files into a resource area from information included in the header, loading the playback control command file into an action area, and loading the script file into a script area;
b) executing an update script to update at least one of the script files while playing the content;
c) changing at least one of the script files stored in the script area to a new script file downloaded through a network under the control of the update script;
d) sequentially reading the object files loaded into the resource area according to the playback control command loaded into the action area and the script loaded into the script area and generating frame data to be played; and
f) playing the generated frame data.

14. The method of claim 13, wherein the operation b) is a process for executing an update script in relation to a frame played in a predetermined time while playing the content.

15. The method of claim 13, wherein the operation b) includes:
checking a queue for storing events upon generation of a new frame to determine whether or not there is an update script defined in relation to an event currently generated; and
executing the update script when the update script is present.

16. The method of claim 15, wherein the event of is at least one of a key operation event and a timer event.

17. The method of claim 15, wherein the event of is an event in which a value of updated data satisfies a predetermined condition as the content is played.

18. The method of claim 13, further comprising, after the operation d):
e) changing the content stored in the permanent storage area of the memory to a new content in which a script file is substituted by the updated script file.

19. A recording medium for storing multimedia content that includes a header, which has summary information concerning the content, object files, which are elements of the content to be played, a playback control command file, which operates the object files and describes the content, a script file, which describes the size, motion, or characteristic of an object, and an update script file, which controls updating of the script file,
wherein the update script file acts to substitute at least one of script files that describe the object by a new script file downloaded through a network.

20. The recording medium of claim 19, wherein the update script file is configured to check events stored in an event queue and to be executed when an event occurs.
